(19) United States
(12) Patent Application Publication
(10) Pub. No.: US 2003/0039013 A1
(43) Pub. Date: Feb. 27, 2003

(54) Dynamic dispersion compensation in high-speed optical transmission systems

(76) Inventors: David J. Jones, Concord, MA (US); Erik R. Thoen, Cambridge, MA (US); Morris P. Kesler, Bedford, MA (US); Lawrence J. Kushner, Andover, MA (US)

Correspondence Address: MILLS & ONELLO, LLP, Suite 605, Eleven Beacon Street, Boston, MA, 02108, US

(21) Appl. No.: 10/180,759

(22) Filed: Jun. 26, 2002

Related U.S. Application Data
(63) Continuation-in-part of application No. 09/939,852, filed on Aug. 27, 2001.

(51) Int. Cl. H04B 10/12; H04B 10/06

(52) U.S. Cl. 359/161; 359/110; 359/173; 359/158; 359/189; 359/195

(57) ABSTRACT

In a system and method for dynamic compensation, one or more spectral components within the electrical spectrum of the received data signals is used for adjusting the dispersion of the received signals to provide a dispersion-compensated signal. In one example, the amplitude of the tone of the transmission bit rate of the received signals is determined and employed as the primary spectral component used for the compensation process. The amplitude of the tone of the transmission bit rate is directly related to dispersion, and therefore, the dispersion compensation process is not adversely impacted by other unrelated variables in the communication system, and accurate dispersion compensation is achieved.

### RELATED APPLICATIONS

This application is a continuation-in-part application of U.S. Ser. No. 09/939,852, filed Aug. 27, 2001, the contents of which are incorporated herein by reference, in their entirety.

### BACKGROUND OF THE INVENTION

Data signals traversing transmission fibers employed in optical communication systems commonly experience group velocity dispersion (GVD). GVD causes different wavelength signals to travel at different speeds in a common medium. Since optical signals are commonly composed of a range of wavelengths, GVD can cause pulse distortion by spreading the pulses in the time domain. Such a temporal spread is referred to in the art as frequency ‘chirp’, since the different wavelengths arrive at the receiver at different times. The magnitude of the pulse distortion is proportional to the distance of signal propagation; in general, as the length of the fiber increases, so too does GVD.

Depending on the complexity of receiver design, dispersive pulse distortion alone can degrade the bit error rate of a transmission system, where the bit error rate is a common gauge of a system's effectiveness. In addition, pulse spreading can cause the tail end of a first pulse to interfere with the front end of an adjacent pulse. Such interference between bit slots can further degrade the system bit error rate.

Conventional transmission systems operating at slower bit transmission rates, for example 2.5 and 10 Gb/s rates, have a relatively large tolerance for GVD, as compared to contemporary systems operating at, for example, 40 Gb/s rates. For this reason, GVD compensation has not been a critical issue for lower bandwidth optical communication systems. However, with the advent of higher bandwidth, and longer distance, systems, GVD compensation has recently become an important consideration, and has taken the form of passive compensation and dynamic compensation.

In passive GVD compensation systems, dispersion compensating fiber (DCF), higher-order mode fiber, Bragg grating devices, and etalon devices are employed to reverse the effects of GVD. In such systems, these fixed-dispersion devices are installed at intervals along a transmission line, for example at periodic relay amplifiers, to cure the GVD effects incrementally. However, since GVD varies with wavelength, a different amount of DCF compensation is needed for each signal at a different wavelength, for example in a wavelength division multiplexed system which utilizes multiple wavelengths. The amount of GVD can also vary in a given communication link over time with changes in environmental effects, such as temperature.

In view of this, active compensation systems have evolved, taking the form of tunable dispersion devices. These devices allow for independent adjustment of GVD compensation at each wavelength. Additional adjustments can be made, for example over time, to compensate for environmental effects such as temperature, aging of the communication medium, chemical composition of the medium, and physical strain on the medium.

In contemporary systems, the bit error rate of the received data is calculated and employed as a feedback signal for controlling the extent of GVD compensation by the tunable dispersion device. However, bit error rate also depends on other variables that are unrelated to dispersion, including the polarization state of the signal, center wavelength of the signal, power fluctuations in the equipment, and interference from adjacent channels in the system. In view of this, the GVD compensation process may be adversely impacted by such sources of error that are unrelated to dispersion.

### SUMMARY OF THE INVENTION

The present invention is directed to a system and method for dynamic GVD compensation by which one or more spectral components within the electrical spectrum of the received data signals is used for adjusting the dispersion of the received signals to provide a compensated signal. In one example, the amplitude of the frequency tone at the transmission bit rate of the received signals is determined and employed as the primary spectral component used as a feedback signal, or error signal, in the compensation process. Since the amplitude of the frequency tone of the transmission bit rate is directly related to the amount of dispersion experienced by the signal, the dispersion compensation process is not adversely impacted by other unrelated sources of error in the communication system, and accurate dispersion compensation is therefore achieved.

In one aspect, the present invention is directed to a system for compensating for dispersion in received data signals in a data communication network. The data signals are characterized by an electrical spectrum comprising at least one spectral, or frequency, component and a transmission bit rate. A spectral unit determines an amplitude of at least one spectral component within the electrical spectrum of the received data signals. A tunable dispersion device modifies dispersion in the received data signals based on the amplitude of the at least one spectral component.

In one embodiment, a control unit controls the tunable dispersion device to modify the dispersion in the received data signals. The control unit may take the form of a circuit type selected from a group consisting of an analog feedback circuit; a digital feedback circuit; a digital signal processing (DSP) circuit; a field-programmable gate array (FPGA) circuit; an application specific integrated circuit (ASIC); and a microprocessor.

In one embodiment, the at least one spectral component may comprise a tone of the transmission bit rate, for example a lowest-order tone. The control unit may control the tunable dispersion device to modify the dispersion in the received data signals: such that the amplitude of the tone of the bit rate is minimized or maximized; such that the amplitude of a higher-order harmonic of a lowest-order tone of the bit rate is minimized or maximized; such that the amplitudes of multiple tones of the bit rate are minimized or maximized; such that the amplitude of a sub-harmonic, or fractional-harmonic, of the tone of the bit rate is minimized or maximized; such that a spectral hole in the electrical spectrum is maximized or minimized.

Dispersion in the received data signals may be attributed to group velocity dispersion of optical data signals transmitted over a fiber. The received data signals are transmitted on a channel comprising an optical data channel.

In another embodiment, the at least one spectral component comprises a tone of the transmission bit rate and a bit error rate unit determines bit error rate in the received data signals. A combiner unit combines the bit error rate with the amplitude of the tone of the bit rate to generate a combined error signal and the tunable dispersion device modifies dispersion in the received data signals based on the combined error signal.

In another embodiment, the at least one spectral component comprises a tone of the transmission bit rate, and the amplitude of the tone of the transmission bit rate is determined by a clock recovery unit. The clock recovery unit comprises a primary phase detector for processing the received data signals, and for combining the received data signals with a feedback signal to generate a phase difference signal. An auxiliary phase detector processes the received data signals, and combines the received data signals with the feedback signal to generate a signal strength indicator that is indicative of the amplitude of the tone of the transmission bit rate. A gain equalizer normalizes the phase difference signal by the signal strength indicator. An oscillator provides a clock signal based on the normalized phase difference signal, and provides the clock signal as the feedback signal. The gain equalizer may comprise a divider for dividing the phase difference signal by the signal strength indicator. The divider comprises a reciprocal unit for generating a reciprocal of the signal strength indicator and a first multiplier for multiplying the reciprocal of the signal strength indicator by the phase difference signal. The divider may further comprise a second multiplier for multiplying the signal strength indicator or the reciprocal of the signal strength indicator by a gain adjustment signal.

The tunable dispersion device may comprise a device selected from the group of devices consisting of: an adjustable Bragg grating; an adjustable free-space grating; an adjustable Fabry-Perot device; an adjustable etalon device; an adjustable ring resonator device; and an adjustable material dispersion device.

In another embodiment, the data signals are transmitted on an optical data channel, and the spectral unit comprises a converter for converting the optical data signals to electrical data signals. A filter in the spectral unit filters the at least one spectral component from the electrical spectrum of the electrical data signals. An amplitude unit generates a signal representative of the amplitude of the at least one spectral component.

In another aspect, the present invention is directed to a method for compensating for dispersion in received data signals characterized by an electrical spectrum comprising at least one spectral component in a data communication network. The method comprises determining an amplitude of at least one spectral component within the electrical spectrum of the received data signals. Dispersion in the received data signals is then modified based on the amplitude of the at least one spectral component.

### BRIEF DESCRIPTION OF THE DRAWINGS

The foregoing and other objects, features and advantages of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic diagram of a first system for compensating for group velocity dispersion (GVD) in an optical communication channel, in accordance with the present invention.

FIG. 2 is a schematic diagram of a second system for compensating for group velocity dispersion (GVD) in an optical communication channel, in accordance with the present invention.

FIG. 3A is a schematic diagram of an error signal unit for generating an error signal for the systems of FIGS. 1 and 2, in accordance with the present invention. FIG. 3B is a spectral chart illustrating the operation of the unit of FIG. 3A.

FIG. 4 is a schematic diagram of a clock recovery unit for generating the error signal for the systems of FIGS. 1 and 2 in accordance with the present invention.

FIG. 5 is a schematic diagram of a third system for compensating for group velocity dispersion (GVD) in an optical communication channel, in accordance with the present invention.

FIG. 6 is a detailed schematic diagram of a clock recovery unit for generating the error signal of FIGS. 1 and 2 in accordance with the present invention.

FIGS. 7A-7C are schematic diagrams of gain equalizer embodiments for normalizing the phase difference signal by the signal strength of the incoming data stream in the clock recovery unit, in accordance with the present invention.

### DETAILED DESCRIPTION OF PREFERRED EMBODIMENTS

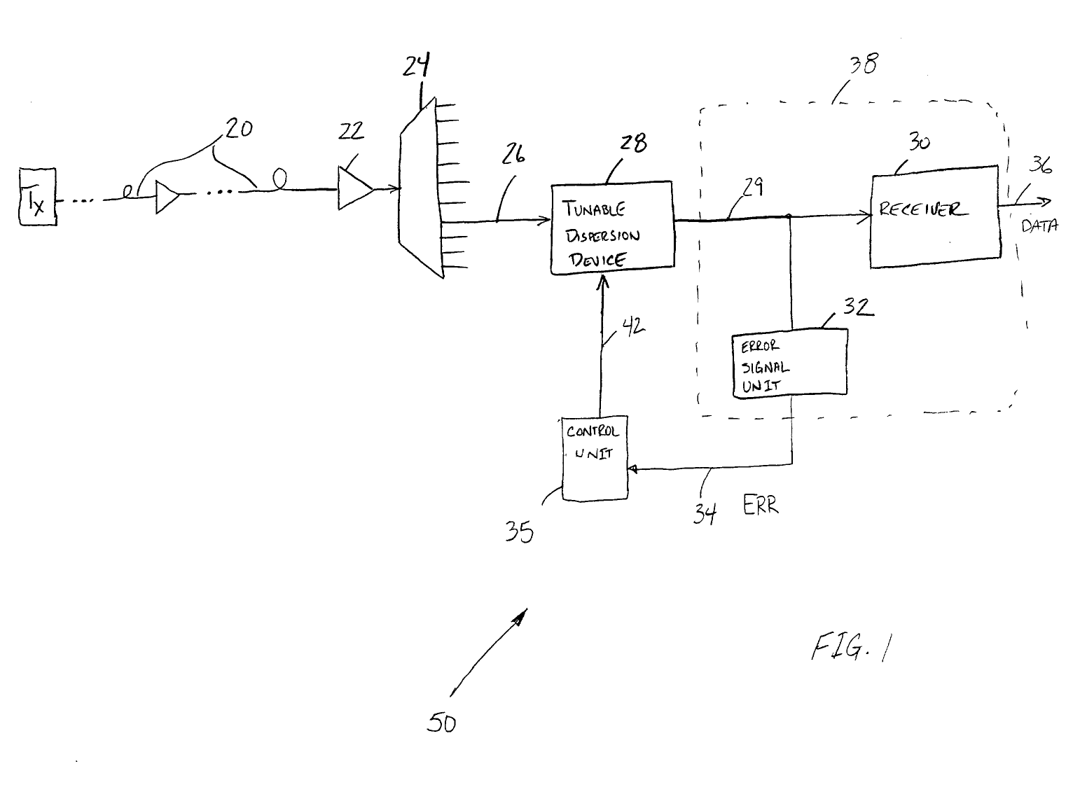

With reference to the block diagram of FIG. 1, in a first embodiment of the dispersion compensation system of the present invention, data signals transmitted by a transmitter Tx, are received, for example, over a transmission fiber 20 or multiple cascaded transmission fibers 20. The signals are transmitted over multiple data channels at multiple wavelengths, the channels each simultaneously carrying data that utilize the channel wavelength as a carrier wavelength. As explained above, data on each channel are subject to wavelength-dependent group velocity dispersion (GVD).

Each transmission fiber is optionally coupled to an amplifier 22, for example an erbium-doped fiber amplifier (EDFA) or a Raman amplifier. The amplifier 22 increases power in the received data, thereby recovering for any attenuation experienced during transmission. The amplifier 22 is preferably broadband, such that all data channels are amplified.

The amplified signal is provided to an optical demultiplexer 24, which separates the received optical data according to individual channel wavelengths. The data signals for each channel are output to an independent channel-specific output fiber 26. In one embodiment, the demultiplexer 24 may comprise an arrayed waveguide grating (AWG) demultiplexer.

The demultiplexed optical data on each channel 26 are next presented to a dispersion compensation system 50 in accordance with the present invention. The dispersion compensation system 50 is optionally duplicated at each channel for providing for compensation of GVD in the respective received channel data. However, for the purpose of the present discussion, a dispersion compensation system 50 at one of the channels will be described.

The dispersion compensation system and method of the present invention employ a tunable dispersion device 28 and a spectral unit 38. The tunable dispersion device 28 modifies dispersion in the data signals on the channel-specific output fiber 26 received on the channel based on the amplitude of at least one spectral component within the electrical spectrum of the received data signals. A spectral unit 38 receives the data signals output by the tunable dispersion device and determines the amplitude of the at least one spectral component.

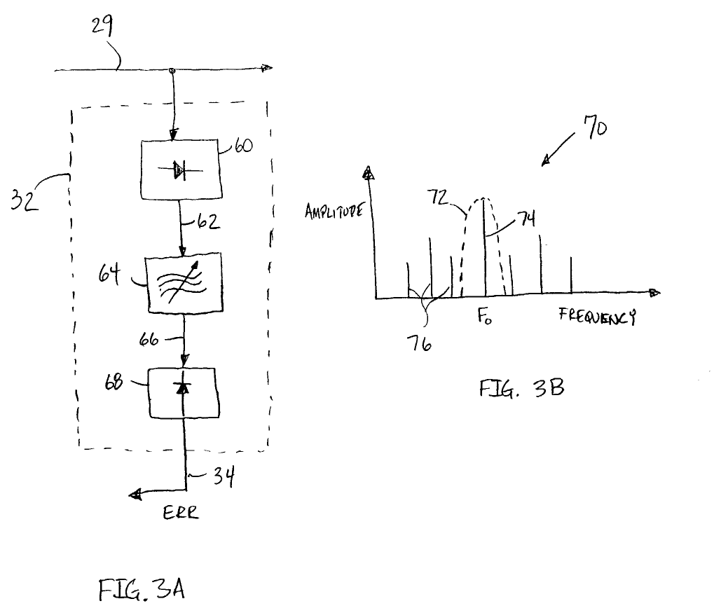

In one example, the spectral component is a tone of the transmission bit rate. The amplitude of the transmission bit rate tone is used as a feedback variable, referred to herein as an error signal ERR, by the tunable dispersion device 28, for modifying the dispersion in the received data signals 26. The spectral unit 38 may comprise a data receiver 30 and error signal unit 32 for determining the amplitude of the transmission bit rate tone, and for generating the error signal ERR. Embodiments of the error signal unit 32 are described in detail below with reference to FIGS. 3, 4, and 6.

The tunable dispersion device 28 is an optical device that receives the optical data signals 26 on the channel and generates an optical output signal 29. The optical output signal 29 has a modified dispersion characteristic, the degree of modification being adjustable based on an applied control signal voltage 42. In one embodiment, the optical output signal 29 comprises a dispersion-compensated signal, whereby the tunable dispersion device 28 modifies the received optical signal 26 to provide a dispersion value that is equal in magnitude to, and opposite the sign of, the dispersion experienced by the data signals during transmission over the optical fiber 20, and during amplification at amplifier 22, and demultiplexing at demultiplexer 24.

A number of tunable dispersion devices taking various forms are commercially available from a number of vendors. One such device, available from JDS Uniphase, Inc., employs a dispersion compensation grating (DCG) based on Bragg gratings imposed on an optical fiber. In another device available from JDS Uniphase, Inc., an etalon structure is employed. Avanex, Inc. offers tunable dispersion devices based on a virtually-imaged phase array (VIPA). Other forms of tunable dispersion devices are equally applicable, for example a free-space grating, a Fabry-Perot device, or a ring-resonator device. Each of these examples performs the same basic function, namely to provide an optical output signal that has a modified dispersion that is controlled based on an applied control voltage.

The receiver 30 receives the dispersion-modified optical data 29 and generates an electrical representation 36 of the optical data signal 29. In one example, the receiver 30 comprises a photodiode.

The error signal unit 32 also receives the dispersion-modified optical data 29 (or, alternatively, the converted electrical signal 36 from the receiver 30) and generates a signal 34, referred to herein as an error signal ERR, that is representative of the strength, or amplitude, of the received data signals.

FIG. 3A is a schematic diagram of an embodiment of the error signal generator 32. A photodetector 60 converts the dispersion-modified optical signal 29 to an electrical signal 62. FIG. 3B is an exemplary representation of the electrical signal 62 in the frequency domain. The spectrum 70 of the electrical signal 62 is composed of various tones 76, or spectral components. In one example, the amplitude of a specific tone 76 in the spectrum 70 is determined as the tone that is proportional to the pulse width of the received signals.

The specific tone to be examined may comprise, for example, the bit rate tone F₀ 74. The spectrum 70 is therefore presented to a tunable filter 64 that is adjusted to pass the band energy 72 in the region of interest surrounding the bit rate tone Fₒ. The resulting filtered energy 66 is passed to a diode 68 that determines the amplitude of the bit rate tone Fₒ 74. The amplitude information is used as feedback error signal ERR 34, for example in the form of a low-frequency voltage signal, that is provided to the control unit 35 (see FIG. 1) for adjusting the tunable dispersion device 28.

While the above example generates the error signal ERR based on the bit rate tone F₀, other spectral components of the signal 70 may be employed to generate the error signal ERR. For example, sub-harmonics, fractional-harmonics, or harmonics of the bit rate tone may be used, as well as a combination of spectral components.

Returning to FIG. 1, the error signal 34 ERR, for example, the amplitude of the tone of the transmission bit rate as determined by the error signal unit 32, is provided to a control unit 35. The control unit 35 generates a control signal 42 for use by the tunable dispersion device 28 for adjusting the level of dispersion applied by the tunable dispersion device 28, such that the modified signals 29 meet certain criteria, for example those criteria discussed in the following paragraphs.

In one example, the control unit 35 may generate an appropriate control signal 42 in response to the error signal ERR to cause the tunable dispersion device 28 to modify the dispersion in the received data signals such that the amplitude of the tone of the transmission bit rate is minimized or maximized. For example, the amplitude of the lowest-order tone may be minimized or maximized.

In other examples, the control unit 35 generates a control signal 42 to cause modification in the dispersion of the received data signals such that the amplitude of a higher-order harmonic of a lowest-order tone of the bit rate tone is minimized or maximized; such that the amplitudes of multiple tones of the bit rate are minimized or maximized; such that the amplitude of a sub-harmonic of the tone of the bit rate is minimized or maximized; such that a spectral hole in the electrical spectrum is maximized or minimized; or such that the amplitude of the spectral component is at an optimal level for the system.

The control unit 35 may be employed as any of a number of circuit configurations capable of processing the spectral component data 34 for generating the control signal 42. For example, the control unit 35 may comprise an analog feedback circuit; digital feedback circuit; digital signal processing (DSP) circuit; field-programmable gate array (FPGA) circuit; application specific integrated circuit (ASIC); or a microprocessor. For example, a microprocessor may be programmed to generate a step voltage signal 42, or digital signal 42, in response to a variance in the error signal ERR. For example, assuming an increase or no change in the error signal ERR, the control unit 35 may be programmed to periodically respond by increasing the voltage or digital value of the signal 42. Assuming a decrease in the error signal ERR, the control unit 35 may be programmed to respond by decreasing the voltage or digital value of the signal 42. Other embodiments of the control unit are equally applicable to the present invention, depending on the system application.

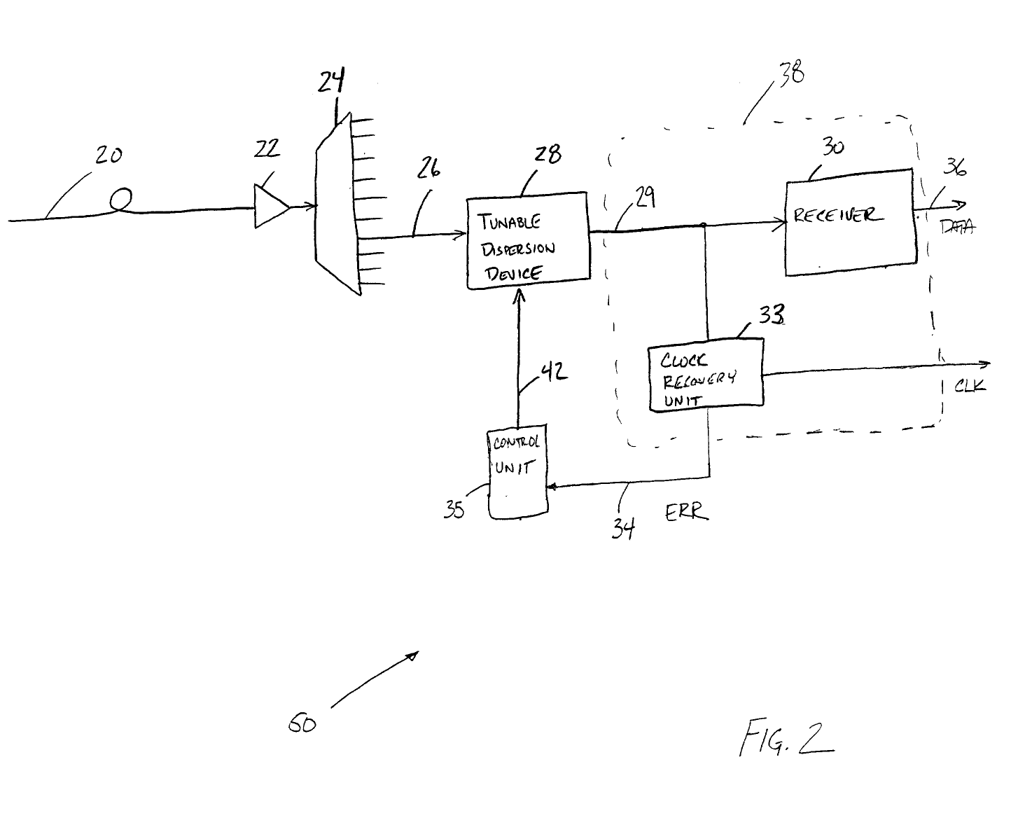

With reference to the schematic block diagram of FIG. 2, in one embodiment of the present invention, the error signal unit 32 (of FIG. 1) comprises a clock recovery unit 33. The clock recovery unit 33 receives the dispersion-modified optical data 29 and extrapolates an electronic clock signal CLK from the data 29. The clock signal CLK is used by the receiving system to synchronize reading of the received data DATA 36. As described in detail below, the clock recovery unit 33 further provides an error signal ERR 34 that is representative of the strength, or amplitude, of a spectral component of the received data signals. This signal is referred to below in the detailed discussion of the clock recovery unit 33 as the “signal strength indicator” signal.

In one example, the clock recovery unit 33 determines the tone of the transmission bit rate, the amplitude of which is provided as the error signal ERR. As described above, this system employs the bit rate tone as the primary feedback variable, or spectral component, for modifying the dispersion in the received data signals. The clock recovery unit 33 generates the signal strength indicator signal, which is employed by the compensation system and method of the present invention as the error signal to modify the dispersion in the received data signals.

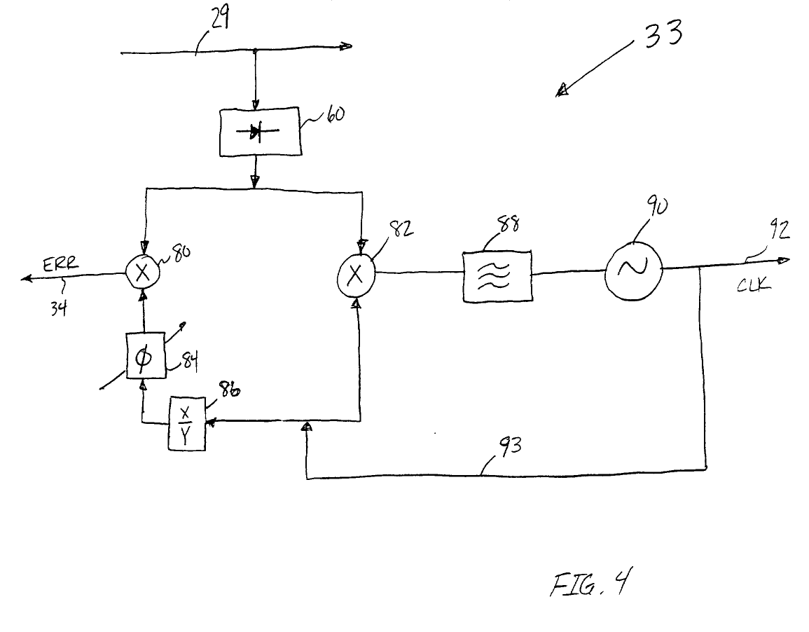

FIG. 4 is a schematic block diagram of an embodiment of the clock recovery unit 33. The clock recovery unit 33 receives the dispersion-modified optical signal 29 at converter 60. The converter 60, for example a photodiode, converts the optical signal to an electrical signal. The electrical signal is provided to a primary phase detector 82 and auxiliary phase detector 80. The auxiliary phase detector 82 forms part of a phase locked loop (PLL) that includes an active loop filter 88 and oscillator 90. The clock signal CLK 92 is extracted from the output of the oscillator 90, as described in further detail below. The clock signal is also provided as a feedback signal 93 to the primary phase detector 82, as shown.

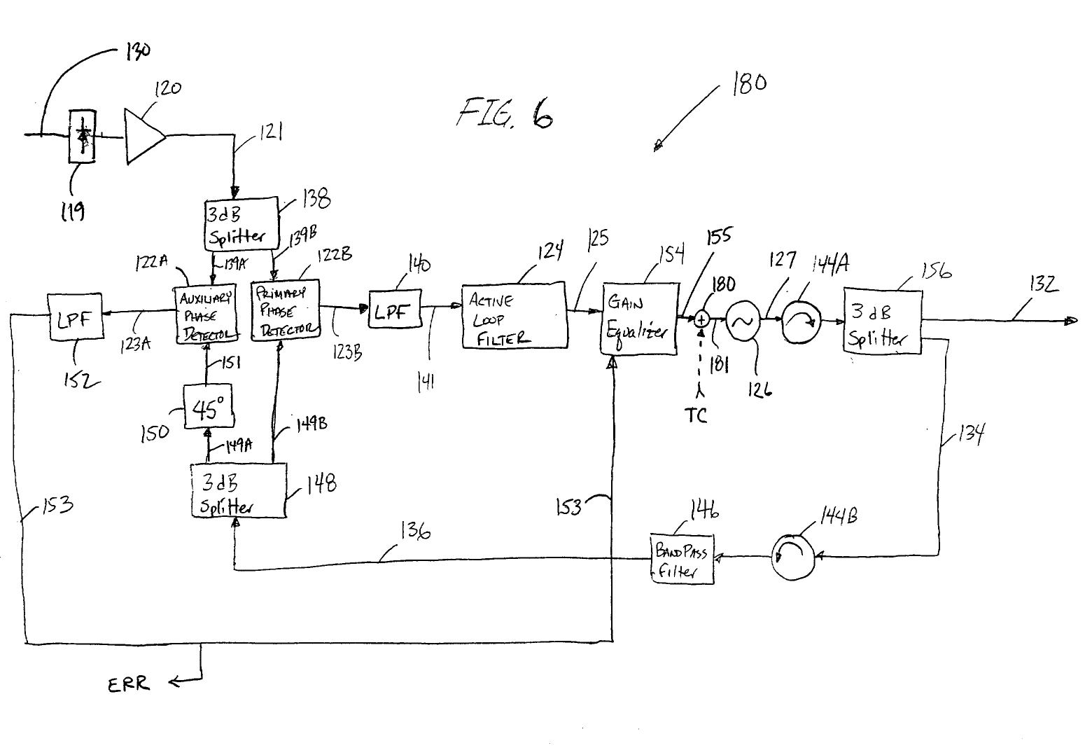

The auxiliary phase detector 80 receives as a first input the output of the converter 60. As the second input of the auxiliary phase detector 80, the feedback signal 93 is processed by a frequency multiplier or frequency divider 86, the output of which is shifted in phase by an adjustable phase shifter 84. The output of the phase shifter is provided as the second, feedback, input to the auxiliary phase detector 80. The output of the auxiliary phase detector 80 is related to the amplitude of the spectral component at issue, for example the tone of the bit rate, and is provided to the control unit 35 as the error signal ERR 34. Detailed operations of this embodiment are described below with reference to FIG. 6

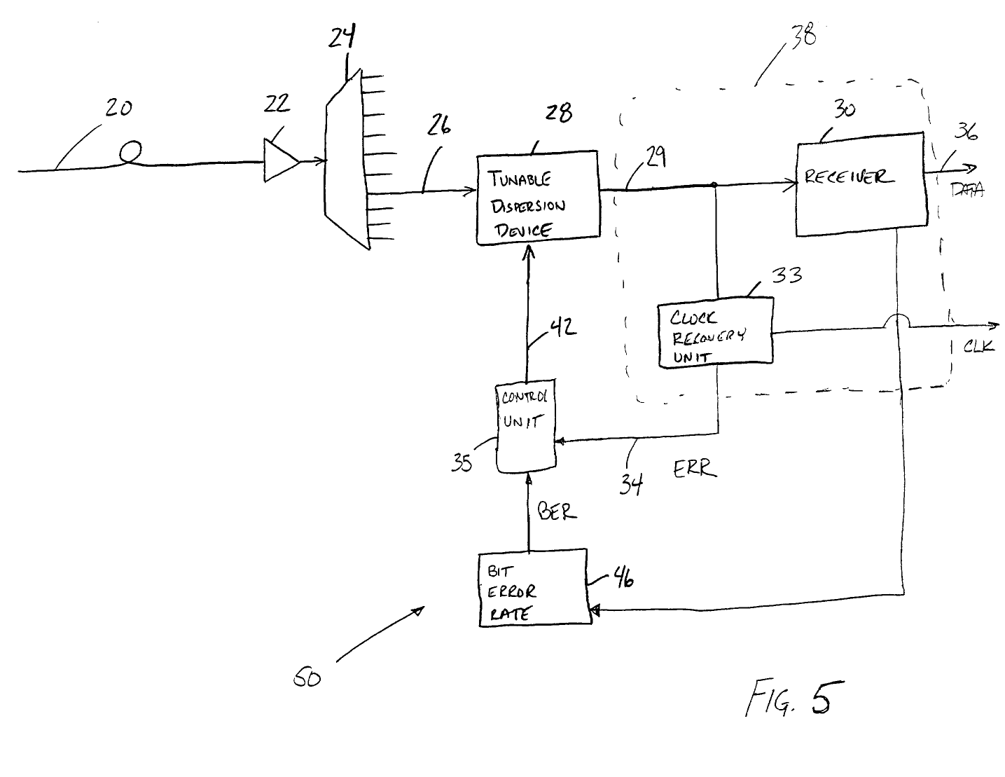

With reference to FIG. 5, in an alternative embodiment, the control unit 35 further generates the control signal 42 for modifying dispersion in the received data signals based on bit error rate 46. The bit error rate 46 is determined at the receiver, for example by known techniques such as a dual decision circuit, examination of SONET overhead bytes, or through forward error correction statistics. The bit error rate varies over many orders of magnitude as a function of many variables, including GVD, and therefore, in a preferred embodiment, the logarithm of the bit error rate is utilized in order to scale the information to a linear relationship. The control unit 35 may factor the bit error rate 46 information with the amplitude of the spectral component 34 according to a range of weightings, depending on the application. The combined control signal 42 is used by the tunable dispersion device to control modification of the received data signals 26. In one example, the control signal may comprise the sum of a weighted error signal ERR, with the weighted logarithm of the bit error rate BER signal. This bit error rate embodiment is applicable to both a system that utilizes the error signal unit 32 of FIG. 1, and a system that utilizes the clock recovery unit 33 of FIGS. 2 and 5.

FIG. 6 is a detailed schematic block diagram of an embodiment of the clock recovery unit 33. This embodiment of the clock recovery unit 33 utilizes linear, constant-gain amplifiers operating at the reference frequency and employs a phaselocked loop (PLL) to perform narrowband filtering. In one embodiment, a quadrature mixer arrangement is used, in the form of primary and auxiliary phase detectors, where the auxiliary phase detector is used to provide a measure of the input signal strength, referred to herein as the “signal strength indicator”. The output of the primary phase detector, in the form of a phase-difference signal, is normalized by the signal strength indicator to a constant level. Through normalization, constant PLL performance is achieved over a wide range of input data signal tone levels. The signal strength indicator can additionally be used as an error signal by other components of the communication system, for example used as an indication of the amplitude of the tone of the transmission bit rate, i.e. signal 34, by the dispersion compensation system 50 of the present invention.

In this manner, this embodiment of the clock recovery unit 33 achieves optimal results and stable response using inexpensive normalization components at baseband, for example, off-the-shelf operational amplifiers and analog multipliers/dividers. This is in contrast with the conventional techniques for compensating for input signal amplitude fluctuations, which employ expensive and complicated microwave circuits for attempting such compensation at the much higher carrier frequencies, to achieve relatively marginal results.

The conventional automatic gain control (agc) loop employs an rf detector, a gain-control element, and a high-gain operational-amplifier stage configured in a closed loop. As the time-varying signal level on the detector increases, the loop responds by lowering the gain in order to keep the detected signal level equal to a predetermined reference. The conventional approach is not applicable to a baseband phaselocked loop approach, as employed by the clock recovery unit of this embodiment, since, when the loop locks, the AC component to be detected disappears and a DC level is present. This DC level is thus no longer an indication of signal strength. Instead, the DC level is set by the phaselocked loop to keep the phaselocked loop in a locked condition.

In contrast, the feed-forward agc configuration of the clock recovery unit 33 disclosed herein is operable when the phaselocked loop is locked and only DC levels are present. In order to preserve constant phaselocked loop performance, the feed-forward gain control configuration of the present invention must perfectly compensate for input signal level changes without the benefit of a high-gain loop to remove non-linearities. This configuration provides for this, by generating a gain control signal in the form of a signal strength indicator which is then applied to a divider, for example an analog divider, and multiplied by the primary phase detector output, which serves to normalize the phase difference signal exactly, and which is also used as an error signal 34 by the control unit 35 in modifying the dispersion in the received data signals. This approach is limited in speed only by the speed of the analog multipliers and dividers. No additional high-gain agc loop circuitry is required, and therefore, exposure to the associated dynamics is prevented.

In an alternative embodiment, the process of normalization can occur in the digital domain by digitizing the phase detector outputs performing the normalization, and then converting back to the analog domain using digital-to-analog converters. However, the entirely analog approach discussed herein as the preferred embodiment provides a simple, low-power solution that mitigates the introduction of spurious noise into the phaselocked loop. The analog approach further offers highly reduced latency, allowing it to be employed with higher loop bandwidths, while maintaining stable operation.

With reference to FIG. 6 an optical input data signal, for example optical data signal 29, is received at input terminal 130 and converted to an electrical signal by converter 119. The input data signal may, for example, take the form of a high-bandwidth serial data stream, for example, a 21.32 GHz optical data stream composed, for example, of non-return-to-zero (NRZ) or return-to-zero (RZ) signal pulses. The data pulses are transmitted by a remote transmitter using a clock as a synchronization source, and propagate through the transmission medium to the receiver. The receiver receives the data pulses without the clock pulse, and thus clock recovery techniques are employed to take advantage of the clock component at either the bit rate, or for example, half the bit rate, inherent in the data pulses to extract the clock signal from the received data stream.

The input data signal is amplified by linear amplifier 120. The linear amplifier does not limit the amplitude of the resulting amplified signal 121, but instead, retains the input signal strength information in the amplified signal 121 that is presented to the phaselocked loop 180. The linear amplifier may comprise a microwave amplifier hybrid, for example formed of microwave transistors and passive components, or may comprise a monolithic microwave integrated circuit (MMIC) or IC-based amplifier. Since filtering is performed at baseband, both broadband amplifiers and narrowband amplifiers can be used for the linear amplifier, whichever option is the most convenient or practical for a given application.

The phaselocked loop 180 of this embodiment comprises a primary phase detector 122B, an active loop filter 124, a gain equalizer, 154, an oscillator 126, a phase shifter 150, first, second and third splitters 138, 148, 156, a low-pass filter 152, 140, a bandpass filter 146, and isolators 144A, 144B. An auxiliary phase detector 122A and associated low pass filter 152 in combination with the gain equalizer 154 form an open-loop feed-forward gain equalizer leg for effecting the normalization operation, discussed in further detail below.

The amplified input signal 121, is presented to, and split by, the first splitter 138, in the form of a 3 dB splitter 138. The first 3 dB splitter splits the amplified input signal 121 into an auxiliary input signal 139A and a primary input signal 139B, of approximately equal power.

The primary input signal 139B is processed by the primary phase detector 122B, which, for example, may comprise a mixer. The primary phase detector 122B also receives a primary feedback signal 149B from the output of the phaselocked loop (discussed below). The mixer of the phase detector effectively provides the function of multiplying signals in the time domain, which equates to convolution in the frequency domain. In this manner, the output of the phase detector is a signal that is a function of the phase difference between the primary input signal 139B and the primary feedback signal 149B. This output signal is referred to herein as the “phase difference signal” 123B.

In an application where the frequency of the eventual recovered clock output is to be a fraction of, or multiple of, the frequency of the input data signal, a frequency multiplier or frequency divider respectively may be applied to the mixer. For example, in the case of an optical demultiplexer where the input data signal is at a transfer rate of 21.3 GHz, and the recovered clock signal is at a rate of 10.66 GHz, frequency doublers may be employed at the mixers of the primary and auxiliary phase detectors 122B, 122A. The frequency multiplier and mixer components are commonly combined in the art as a single unit and referred as a “harmonic mixer”.

The auxiliary input signal 139A is processed by the auxiliary phase detector 122A, which, in a preferred embodiment, comprises a mixer, as described above. The auxiliary phase detector 122A mixes the auxiliary input signal 139A with a phase-shifted auxiliary feedback signal 151, to provide an output signal referred to herein as a “signal strength indicator” signal 123A. The phase-shifted auxiliary feedback signal 151 is generated by phase shifter 150, which, in the case of the preferred embodiment, provides a 45 degree phase shift of the auxiliary feedback signal 149A. The auxiliary feedback signal 149A is the same signal as the primary feedback signal 149B, by virtue of the second 3 dB splitter 148. The combination of the 45 degree phase shifter 150 with a 2× harmonic mixer of the auxiliary phase detector results in a 90 degree phase shift, and is therefore referred to in the art as a “quadrature mixer”, and is employed in the preferred embodiment of the present invention. The output signal strength indicator signal 123A is a signal that is a function of the amplitude of the input signal 130, by virtue of the phase shift of the auxiliary feedback signal 149A.

The signal strength indicator 123A is filtered by low pass filter 152, for example comprising a capacitor, for eliminating sum frequencies from the signal and for passing the DC information in the signal. The resulting filtered signal strength indicator signal 153 is fed forward to the gain equalizer, where it is used to normalize the phase difference signal 123B of the phaselocked loop. The signal strength indicator signal 153 may be further distributed as an error signal SSI/ERROR to be used by other receiver subsystems, including the dispersion compensation system 50 of the present invention.

The effect of the normalization is to make the performance of the phaselocked loop insensitive to input signal amplitude. The normalization approach of the present invention recognizes that the output of the primary phase detector 141 is proportional to the input signal level multiplied by the sine of the difference in phase between the primary input signal 139B and the primary feedback signal 149B. Similarly, due the phase shift, the output of the auxiliary phase detector 153 is proportional to the input signal level multiplied by the cosine of the difference in phase between the auxiliary input signal 139A and the phase-shifted auxiliary feedback signal 151. The feed-forward gain equalizer divides the output of the primary phase detector 141 (following filtering at filter 124) by the output of the auxiliary phase detector 153, and therefore cancels out, or effectively removes, the dependence on input signal level. The output of the gain equalizer 155 is thus proportional to the tangent of the difference in phase between the input signal and feedback signal, which, for small phase differences, approximates to the phase difference itself. In this manner, the system and method of this embodiment result in a recovered clock signal that is proportional to phase variations of the input signal, in a manner that is effectively independent of input signal level variations.

The phase difference signal 123B, output by the primary phase detector 122B, is processed by low pass filter 140 (it is possible for the functions of the phase detector 122B and the low pass filter 140 to be combined), and the output signal 141 is presented to the active loop filter 124. The active loop filter 124 controls the dynamic performance of the phaselocked loop, for example acquisition and tracking. The filter 124 may include a combination of analog components, for example operational amplifiers and R-C-L networks in an active configuration, and/or purely R-C-L networks in a passive configuration. Alternatively, the filtering may be performed in the digital domain, for example, converted from an analog to a digital signal, filtered by digital signal processor (DSP) and converted back to an analog signal. In either case, the filter tradeoffs include loop dynamics, noise performance, loop stability, and loop balance. Such filters 124 are well documented in the technical literature.

The resulting filtered phase difference signal 125 is input to the gain equalizer 154, which operates to normalize the filtered phase difference signal 125 by the signal strength indicator signal 153, fed forward by the auxiliary phase detector 122A.

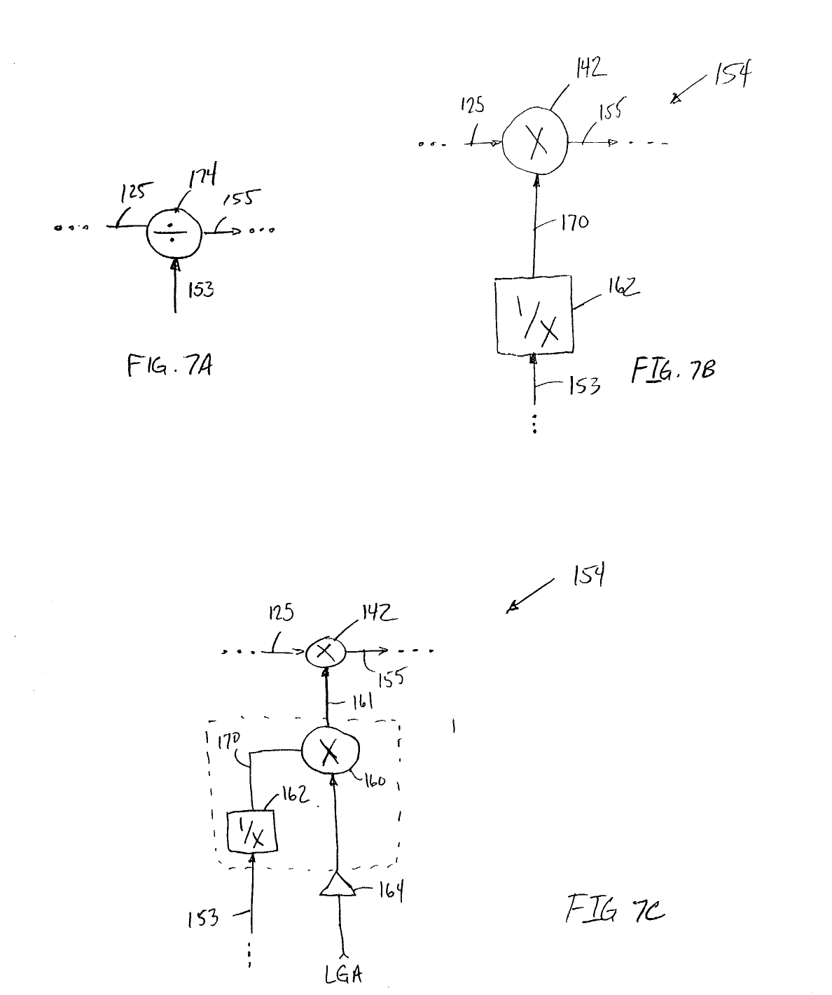

In a preferred embodiment, normalization takes the form of a division operation. For example, the filtered phase difference signal 125 is divided by the signal strength indicator signal 153. With reference to FIGS. 7A-7C, various embodiments are disclosed for performing this operation. Other embodiments for performing the division operation are equally applicable. In FIG. 7A, the filtered phase difference signal 125 is divided by the signal strength indicator signal 153 at divider 174 to generate the normalized output signal 155. In FIG. 7B, the signal strength indicator signal 153 is input to inverse operation 162 which performs a 1/×, or reciprocal, operation on the input signal. The signal strength indicator signal 153 is thus moved to the denominator of the operation at signal 170, which is in turn multiplied with the filtered phase difference signal 125 at multiplier 142. The normalized output signal 155 is output to the phase locked loop 180.

In FIG. 7C a second multiplier 160 is added to accommodate an optional loop-gain adjustment signal LGA, which, for example, can be used to modify the loop gain, and hence the dynamic performance of the phaselocked loop. The loop-gain adjustment signal LGA is buffered by buffer 164 and multiplied by signal 170 at the second multiplier 160. The adjusted signal 161 is multiplied by the filtered phase difference signal 125 at multiplier 142 to provide the normalized output signal.

The normalized phase difference signal 155 is next combined with an optional temperature compensation signal TC at adder 180. The temperature compensation signal TC may be in the form of, for example, a DC signal that is generated as a function of varying system operational temperature. The temperature may be sensed, for example, by thermistors, and the sensed signal converted and processed by a DSP, to provide a suitable DC level for the TC signal.

The resulting adjusted, filtered phase difference signal 181 is next input to an oscillator 126, where the signal 181, for example a DC-level signal is input to a voltage-controlled oscillator (VCO) or current-controlled oscillator comprising the oscillator 126, and is used to adjust the oscillation frequency, based on the DC level of the signal. In the present embodiment, the oscillation frequency of the oscillator is tuned to half of the expected clock frequency of the input data stream, for example 10.66 GHz. The output of the oscillator is the recovered clock signal 127.

The recovered clock signal 127 is provided at the output terminal 132 and is also fed back to the primary and auxiliary phase detectors 122B, 122A as feedback signal 134. A third 3 dB splitter 156 provides each of these signals. Optional first and second isolators 144A and 144B are coupled to the input of the third splitter and the feedback branch of the output of the third splitter 156. The first isolator 144A isolates the operation of the phaselocked loop from load variations in a load coupled to the output terminal. The second isolator prevents the spectral content of the input data stream that passes through the mixers of the primary and auxiliary phase detectors 122B, 122A, from corrupting the output signal 132. The isolators 144A, 144B are preferably non-reciprocal devices, for example taking the form of microwave amplifiers, or magneto-ferrite-based devices.

The feedback signal 134 passes through the second isolator 144B, and is filtered by bandpass filter 146. The bandpass filter prevents data noise from flowing in the reverse direction, and further strips harmonics that may have been generated by the oscillator 126, to prevent the harmonics from causing a DC-level shift at the outputs of the auxiliary and primary phase detectors 122A, 122B.

The filtered feedback signal 136 is split at the second 3 dB splitter 148 and divided into the equivalent primary feedback signal 149B, and auxiliary feedback signal 149A. As explained above, the primary feedback signal 149B is provided to the primary phase detector 122B and mixed with the primary amplified input signal 139B to generate the phase difference signal 123B. At the same time, the auxiliary feedback signal 149A is phase-shifted at phase shifter 150, and the phase-shifted signal 151 is provided to the auxiliary phase detector 122A, where it is mixed with the amplified auxiliary input signal 139A, to generate the signal strength indicator signal 123A.

In the example embodiment described above, the received input data stream 130 is at a transmission rate twice that of the oscillator 126, and desired output clock rate 127. For this reason, 2× harmonic mixers are employed in the primary and auxiliary phase detectors 122B, 122A. Since a 2× harmonic mixer is employed in the auxiliary phase detector 122A, a 45 degree shift is needed in the phase shifter. Assuming a non-harmonic mixer is employed by the auxiliary phase detector 122A, a 90 degree shift in the phase shifter would be necessary.

It should be noted that although the phase shift is shown on the auxiliary leg of the feedback path, other embodiments are possible, and equally applicable. Any embodiment that would place the signals presented to the mixers of the primary and auxiliary phase detectors 122B, 122A in quadrature, i.e. shifted by 90 degrees in phase, would be applicable.

In addition, the present invention performs the normalization operation at baseband. In this manner, a narrow, high-Q filter is provided using baseband components. This effectively places a high-Q filter around the carrier, i.e. clock, frequency by translating the carrier frequency spectrum down to baseband.

In alternative embodiments of the clock recovery unit 33, while the primary and auxiliary phase detectors are described above as including mixers, other implementations of phase detectors are well known and equally applicable. These include digital XOR gates and flip-flop configurations that serve as phase- frequency comparators.

In addition, generally, at relatively low frequencies, for example in the gain equalizer 154, multipliers are used to process signals, while at high frequencies, for example in the primary and auxiliary phase detectors 122B, 122A, mixers are used. Both multipliers and mixers apply equally well to the principles of the present invention, and thus the two terms are defined herein to be used interchangeably.

In this manner dispersion compensation of received data signals is achieved based on a parameter that is directly related to dispersion. Therefore, the compensation process is not adversely impacted by other unrelated sources of error in the communication system.

While this invention has been particularly shown and described with references to preferred embodiments thereof, it will be understood by those skilled in the art that various changes in form and details may be made herein without departing from the spirit and scope of the invention as defined by the appended claims.

We claim:

1. A system for compensating for dispersion in received data signals, the data signals being characterized by an electrical spectrum comprising at least one spectral component, in a data communication network, comprising
a spectral unit that determines an amplitude of at least one spectral component within the electrical spectrum of the received data signals; and
a tunable dispersion device for modifying dispersion in the received data signals based on the amplitude of the at least one spectral component.

2. The system of claim 1 wherein the tunable dispersion device comprises a device selected from the group consisting of: Bragg grating; free-space grating; Fabry-Perot device; etalon device; ring resonator device; and material dispersion device.

3. The system of claim 1 wherein the system further comprises a control unit for controlling the tunable dispersion device to modify the dispersion in the received data signals.

4. The system of claim 3 wherein the control unit comprises a unit selected from a group consisting of analog feedback circuit; digital feedback circuit; digital signal processing (DSP) circuit; field-programmable gate array (FPGA) circuit; application specific integrated circuit (ASIC), and microprocessor.

5. The system of claim 3 wherein the data signals are further characterized by a transmission bit rate and wherein the at least one spectral component comprises a tone of the transmission bit rate.

6. The system of claim 5 wherein the tone comprises a lowest-order tone.

7. The system of claim 5 wherein the control unit controls the tunable dispersion device to modify the dispersion in the received data signals such that the amplitude of the tone of the bit rate is maximized.

8. The system of claim 5 wherein the control unit controls the tunable dispersion device to modify the dispersion in the received data signals such that the amplitude of a higher-order harmonic of a lowest-order tone of the bit rate is minimized or maximized.

9. The system of claim 5 wherein the control unit further controls the tunable dispersion device to modify the dispersion in the received data signals such that the amplitudes of multiple tones of the bit rate are minimized or maximized.

10. The system of claim 5 wherein the control unit further controls the tunable dispersion device to modify the dispersion in the received data signals such that the amplitude of a sub-harmonic of the tone of the bit rate is minimized or maximized.

11. The system of claim 3 wherein the control unit controls the tunable dispersion device to modify the dispersion in the received data signals such that a spectral hole in the electrical spectrum is maximized or minimized.

12. The system of claim 1 wherein the dispersion comprises group velocity dispersion of optical data signals transmitted over a fiber.

13. The system of claim 1 wherein the received data signals are transmitted on a channel comprising an optical data channel.

14. The system of claim 1 wherein the data signals are further characterized by a transmission bit rate and wherein the at least one spectral component comprises a tone of the transmission bit rate and further comprising:
a bit error rate unit for determining bit error rate in the received data signals; and
a combiner unit for combining the bit error rate with the amplitude of the tone of the bit rate to generate a combined error signal and wherein the tunable dispersion device modifies dispersion in the received data signals based on the combined error signal.

15. The system of claim 1 wherein the data signals are further characterized by a transmission bit rate and wherein the at least one spectral component comprises the tone of the transmission bit rate, and wherein the amplitude of the tone of the transmission bit rate is determined by a clock recovery unit.

16. The system of claim 15 wherein the clock recovery unit comprises:
a primary phase detector for processing the received data signals, and for combining the received data signals with a feedback signal to generate a phase difference signal;
an auxiliary phase detector for processing the received data signals, and for combining the received data signals with the feedback signal to generate a signal strength indicator that is indicative of the amplitude of the tone of the transmission bit rate;
an oscillator for providing a clock signal based on phase difference signal, and for providing the clock signal as the feedback signal.

17. The system of claim 16 further comprising a gain equalizer for normalizing the phase difference signal by the signal strength indicator; and wherein the oscillator provides the clock signal based on the normalized phase difference signal.

18. The system of claim 17 wherein the gain equalizer comprises a divider for dividing the phase difference signal by the signal strength indicator.

19. The system of claim 18 wherein the divider comprises a reciprocal unit for generating a reciprocal of the signal strength indicator and a first multiplier for multiplying the reciprocal of the signal strength indicator by the phase difference signal.

20. The system of claim 19 wherein the divider further comprises a second multiplier for multiplying the signal strength indicator or the reciprocal of the signal strength indicator by a gain adjustment signal.

21. The system of claim 1 wherein the data signals are transmitted on an optical data channel, and wherein the spectral unit comprises:
a converter for converting the optical data signals to electrical data signals;
a filter for filtering the at least one spectral component from the electrical spectrum of the electrical data signals; and
an amplitude unit for generating a signal representative of the amplitude of the at least one spectral component.

22. A method for compensating for dispersion in received data signals characterized by an electrical spectrum comprising at least one spectral component, in a data communication network, comprising
determining an amplitude of at least one spectral component within the electrical spectrum of the received data signals; and
modifying dispersion in the received data signals based on the amplitude of the at least one spectral component.

23. The method of claim 22 wherein the step of modifying dispersion in the received data signals is performed at a tunable dispersion device comprising a device selected from the group consisting of: Bragg grating; free-space grating; Fabry-Perot device; etalon device; ring resonator device; and material dispersion device.

24. The method of claim 22 further comprising controlling the tunable dispersion device to modify the dispersion in the received data signals with a control unit comprising a unit selected from a group consisting of analog feedback circuit; digital feedback circuit; digital signal processing (DSP) circuit; field-programmable gate array (FPGA) circuit; application specific integrated circuit (ASIC), and microprocessor.

25. The method of claim 22 wherein the data signals are further characterized by a transmission bit rate and wherein the at least one spectral component comprises a tone of the transmission bit rate.

26. The method of claim 25 wherein the tone comprises a lowest-order tone.

27. The method of claim 25 further comprising modifying the dispersion in the received data signals such that the amplitude of the tone of the bit rate is maximized.

28. The method of claim 25 further comprising modifying the dispersion in the received data signals such that the amplitude of a higher-order harmonic of a lowest-order tone of the bit rate is minimized or maximized.

29. The method of claim 25 further comprising modifying the dispersion in the received data signals such that the amplitudes of multiple tones of the bit rate are minimized or maximized.

30. The method of claim 25 further comprising modifying the dispersion in the received data signals such that the amplitude of a sub-harmonic of the tone of the bit rate is minimized or maximized.

31. The method of claim 22 further comprising modifying the dispersion in the received data signals such that a spectral hole in the electrical spectrum is maximized or minimized.

32. The method of claim 22 wherein the dispersion comprises group velocity dispersion of optical data signals transmitted over a fiber.

33. The method of claim 22 wherein the received data signals are transmitted on a channel comprising an optical data channel.

34. The method of claim 22 wherein the data signals are further characterized by a transmission bit rate and wherein the at least one spectral component comprises a tone of the transmission bit rate and further comprising:
determining bit error rate in the received data signals; and
combining the bit error rate with the amplitude of the tone of the bit rate to generate a combined error signal and wherein modifying dispersion in the received data signals is based on the combined error signal.

35. The method of claim 22 wherein the data signals are further characterized by a transmission bit rate, wherein the spectral component comprises a tone of the transmission bit rate and wherein an amplitude of the tone of the transmission bit rate is determined by:
combining the received data signals with a feedback signal to generate a phase difference signal;
combining the received data signals with the feedback signal to generate a signal strength indicator that is indicative of the amplitude of the tone of the transmission bit rate; and
providing a clock signal based on the phase difference signal, and providing the clock signal as the feedback signal.

36. The method of claim 35 further comprising:
normalizing the phase difference signal by the signal strength indicator; and
providing the clock signal based on the normalized phase difference signal, and providing the clock signal as the feedback signal.

37. The method of claim 35 further comprising dividing the phase difference signal by the signal strength indicator.

38. The method of claim 37 further comprising generating a reciprocal of the signal strength indicator and multiplying the reciprocal of the signal strength indicator by the phase difference signal.

39. The method of claim 22 wherein the data signals are transmitted on an optical data channel, and wherein determining the amplitude of the at least one spectral component comprises:
converting the optical data signals to electrical data signals;
filtering the at least one spectral component from the electrical spectrum of the electrical data signals; and
generating a signal representative of the amplitude of the at least one spectral component.
